(19) United States
(12) Patent Application Publication
(10) Pub. No.: US 2013/0091524 A1
(43) Pub. Date: Apr. 11, 2013

(54) METHOD AND APPARATUS FOR PROVIDING INTEGRATED ELECTRONIC PROGRAM GUIDE (EPG) OF MULTI- INPUT SOURCES

(71) Applicant: NHN Corporation, Seongnam-si (KR)

(72) Inventor: Seongbong HONG, Seongnam-si (KR)

(73) Assignee: NHN Corporation, Seongnam-si (KR)

(21) Appl. No.: 13/646,979

(22) Filed: Oct. 8, 2012

(30) Foreign Application Priority Data
Oct. 11, 2011 (KR) 10-2011-0103443

(51) Int. Cl. H04N 21/462

(52) U.S. Cl. 725/49

(57) ABSTRACT

Provided is a method and apparatus for providing an integrated electronic program guide (EPG). An image display apparatus may receive signals from a plurality of input sources via at least one port, may identify the plurality of input sources, may receive EPG information of each of the plurality of input sources, and may generate an integrated EPG by integrating the received EPG information. Using the integrated EPG, a user of the image display apparatus may select and view all the contents that are provided by the plurality of input sources, without a need to select a predetermined input source.

### CROSS-REFERENCE TO RELATED APPLICATION

This application claims priority from and the benefit of Korean Patent Application No. 10-2011-0103443, filed on Oct. 11, 2011, which is hereby incorporated by reference for all purposes as if fully set forth herein.

### BACKGROUND OF THE INVENTION

1. Field of the Invention

Exemplary embodiments of the present invention relate to a method and apparatus for providing an electronic program guide (EPG), and more particularly, to providing an integrated EPG about multiple input sources.

2. Discussion of the Background

With technical development of broadcast media and sophistication of a broadcast business model, an image display apparatus including a digital television (TV) may employ various broadcast sources as an input source of an image.

Broadcast sources may include, for example, a terrestrial broadcasting, a satellite broadcasting, a cable broadcasting. In addition to unilateral broadcast services via a TV, a broadcast source using a video-on-demand (VOD) streaming scheme such as an Internet protocol TV (IPTV), has been developed as broadcast media. Internet broadcast media providing broadcast sources through the Internet connection have also been rapidly rising in the market. When a console game machine and persona storage media are additionally considered as an input source besides broadcast services, a number of input sources that are provided to a single image display apparatus may significantly increase.

Even before the Internet broadcast media is provided, broadcasting services can be viewed using a large number of broadcast sources, for example, a terrestrial and satellite broadcasting, a terrestrial and cable TV. Also, users entertain contents using, for example, a digital video disc (DVD) player and a network access storage (NAS) device.

To enjoy contents that are provided by various input sources, a user may need to recognize a physical input port of an image display apparatus into which the user's desired content is being input. The user may need to select a predetermined input port and then select a desired channel from many channels using a remote controller of the image display apparatus. In this case, in order to find a desired channel, the user may need to access the desired channel by directly searching an electronic program guide (EPG) provided by a broadcasting company.

When the user is not familiar with manipulating an image display apparatus, the user may experience difficulty when selecting a physical input port of the image display apparatus. In particular, when a person who does not skillfully manipulate an image display apparatus, he/she may not easily view a cable TV, a satellite broadcasting, an Internet broadcasting.

Accordingly, a user may be provided with EPG information in an input display apparatus which is capable of instantaneously verifying information about various channels receivable by the apparatus by the user.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a method and apparatus for generating an integrated electronic program guide (EPG) by receiving EPG information of each of a plurality of input sources.

Exemplary embodiments of the present invention also provide a method and apparatus for identifying a plurality of input sources and receiving EPG information of each of the identified input sources.

Additional features of the invention will be set forth in the description which follows, and in part will be apparent from the description, or may be learned by practice of the invention.

Exemplary embodiments of the present invention provide a method of providing electronic program guide (EPG) information associated with an input display apparatus. The method includes identifying a plurality of input sources, each input source providing a signal to the image display apparatus. The method also includes receiving EPG information of each of the plurality of input sources. The method includes generating an integrated EPG by integrating the EPG information. The method includes outputting the integrated EPG.

Exemplary embodiments of the present invention provide a non-transitory computer-readable recording medium comprising a program, which when executed by a processor, to perform the following method. The method includes identifying a plurality of input sources, each input source providing a signal to the image display apparatus. The method also includes receiving EPG information of each of the plurality of input sources. The method includes generating an integrated EPG by integrating the EPG information. The method includes outputting the integrated EPG.

Exemplary embodiments of the present invention provide an image display apparatus. The apparatus includes at least one port to receive a signal. The apparatus also includes an input source identifying unit to identify a plurality of input sources, wherein a signal of each of the plurality of input sources is provided to the image display apparatus via one of the at least one port. The apparatus includes an electronic program guide (EPG) information receiver to receive EPG information of each of the plurality of input sources. The apparatus includes an integrated EPG generator to generate an integrated EPG by integrating the EPG information. And the apparatus includes an output unit to output the integrated EPG.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an image display apparatus and input sources according to exemplary embodiments of the present invention.

FIG. 2 is a block diagram illustrating a configuration of an image display apparatus according to exemplary embodiments of the present invention.

FIG. 3 is a diagram to describe a method of identifying an input source according to exemplary embodiments of the present invention.

FIG. 4 is a diagram illustrating a method of receiving electronic program guide (EPG) information of an input source according to exemplary embodiments of the present invention.

FIG. 5 is a diagram illustrating a configuration of an integrated EPG according to exemplary embodiments of the present invention.

FIG. 6 is a diagram illustrating a content search according to exemplary embodiments of the present invention.

FIG. 7 is a flowchart of a process for illustrating a method of providing an EPG in an image display apparatus according to exemplary embodiments of the present invention.

FIG. 8 is a diagram of hardware that can be used to implement exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

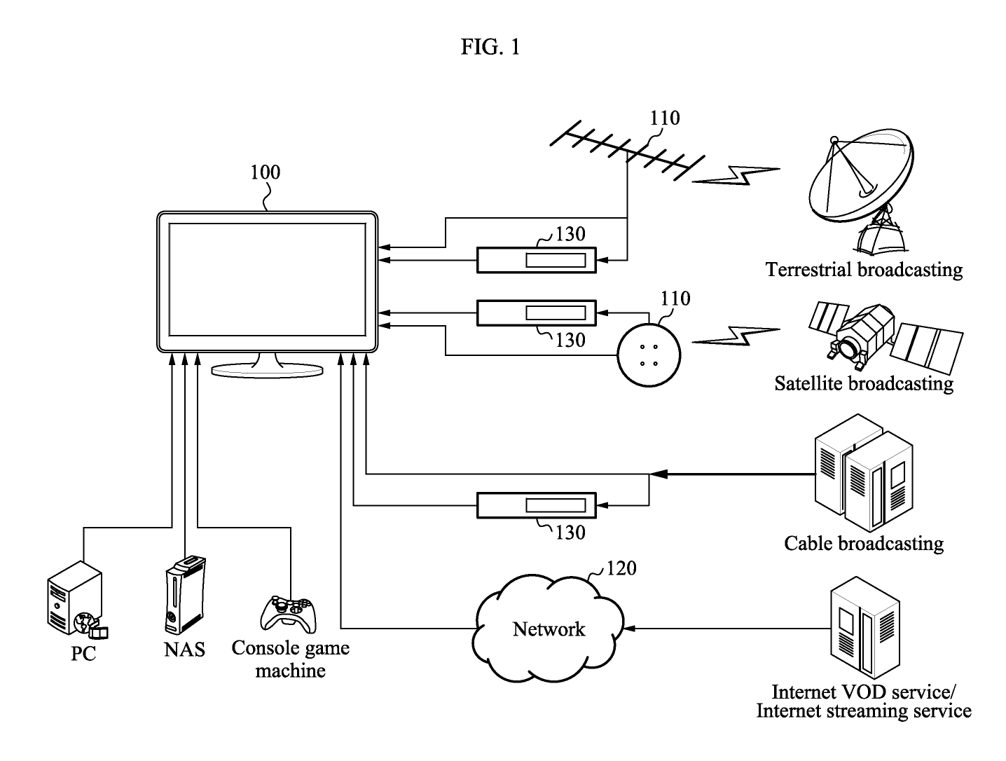

FIG. 1 is a diagram illustrating an image display apparatus 100 and input sources according to exemplary embodiments of the present invention.

The image display apparatus 100 refers to an apparatus that receives signals from the input sources to output contents that are provided by the input sources.

The image display apparatus 100 may use various types of input sources.

The input source may include a broadcast input source, for example, a terrestrial broadcasting, a satellite broadcasting, and a cable broadcasting.

The input source may include an Internet input source, for example, an Internet video-on-demand (VOD) service, and an Internet streaming service.

The input source may include a personal media input source, for example, a personal computer (PC), a console game machine, and a network attached storage (NAS).

A signal of an input source may be directly provided to the image display apparatus 100. The signal of the input source may be provided to the image display apparatus 100 via an antenna 110 that receives a signal, or over a network 120 such as Internet and the like. The signal of the input source may be provided to the image display apparatus 100 using a set-top 130. The set-top 130 may receive a first signal of a predetermined input source, convert the first signal to a second signal executable by the image display apparatus 100, and provide the second signal to the image display apparatus 100.

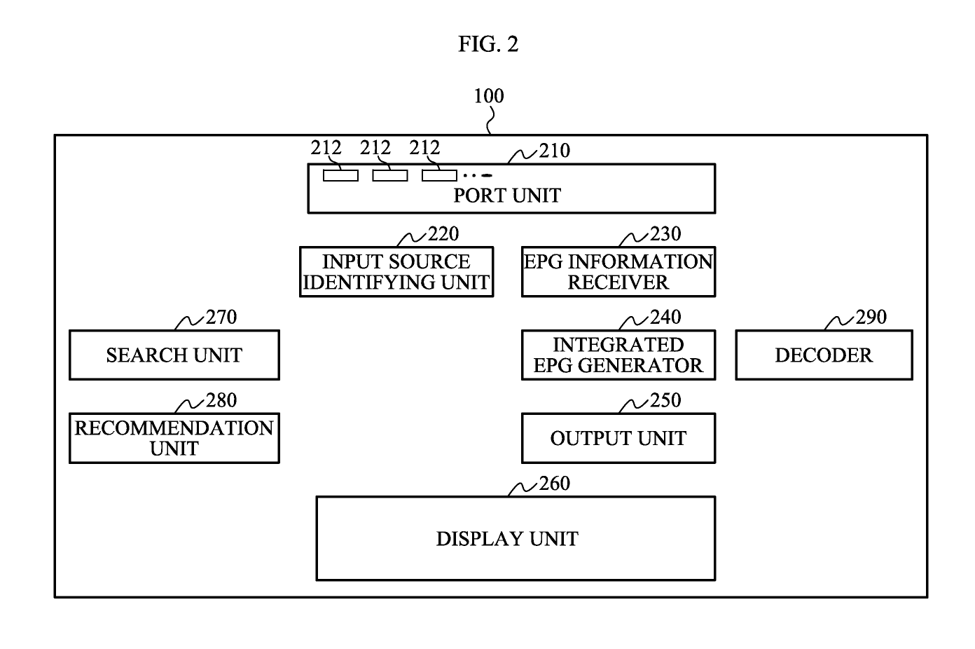

FIG. 2 is a block diagram illustrating a configuration of an image display apparatus 100 according to exemplary embodiments of the present invention.

Referring to FIG. 2, the image display apparatus 100 may include a port unit 210, an input source identifying unit 220, an electronic program guide (EPG) information receiver 230, an integrated EPG generator 240, and an output unit 250. The image display apparatus 100 may further include a display unit 260, a search unit 270, a recommendation unit 280, and a decoder 290.

The port unit 210 may include at least one of ports 212. A signal of each of a plurality of input sources may be provided to the image display apparatus 100 via the port 212.

The port 212 may be a high-definition multimedia interface (HDMI) port, a display port, a component port, a super-video home system (S-VHS) port, or a composite port.

The plurality of input sources may include at least one of a broadcast input source, an Internet input source, and a personal media input source.

Each input source may include at least one channel. At least one content may be transmitted to the image display apparatus 100 in real time via a channel.

The input source identifying unit 220 may identify the plurality of input sources that is provided via each port 212. The input source identifying unit 220 may identify a type of a corresponding input source. In this example, the type of the input source may be classified based on an apparatus that generates the input source, a provider that provides the input source, a transmission scheme of the input source, and the like.

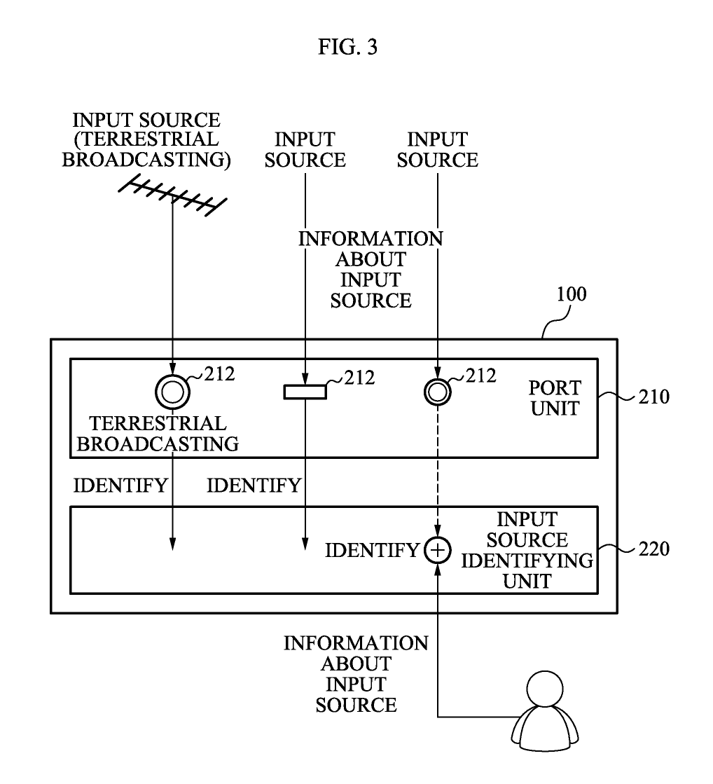

An example of the input source identifier 220 that identifies an input source will be further described with reference to FIG. 3.

The EPG information receiver 230 may receive EPG information of each of the identified input sources. EPG information of each of the plurality of input sources may be provided to the image display apparatus 100 using the EPG information receiver 230.

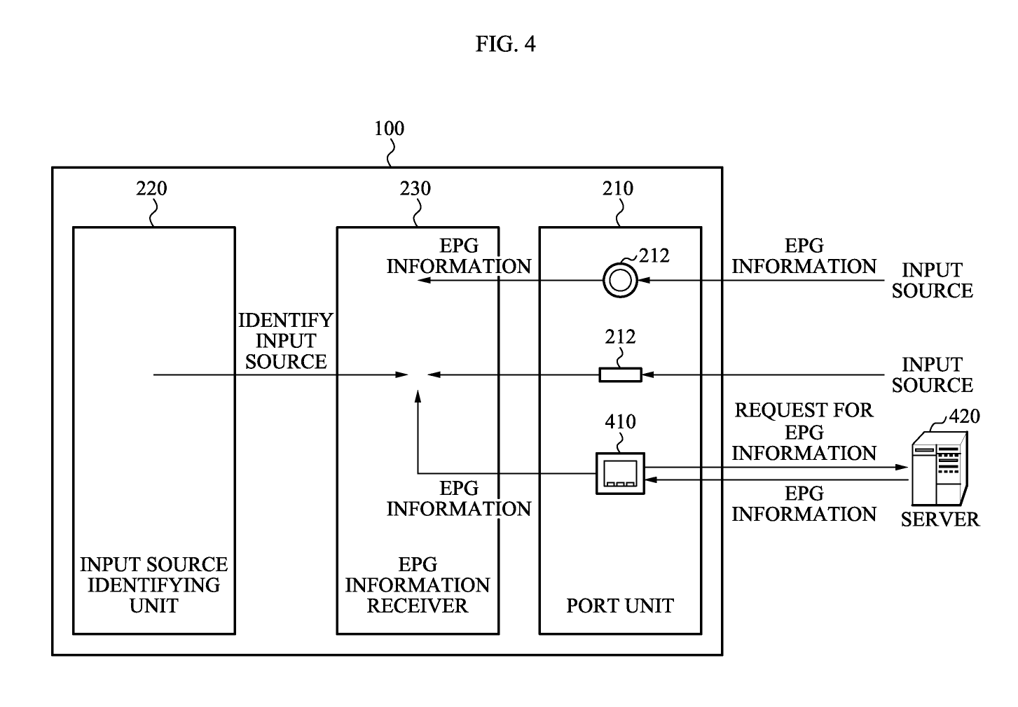

An example of the EPG information receiver 230 that receives EPG information of an input source will be further described with reference to FIG. 4.

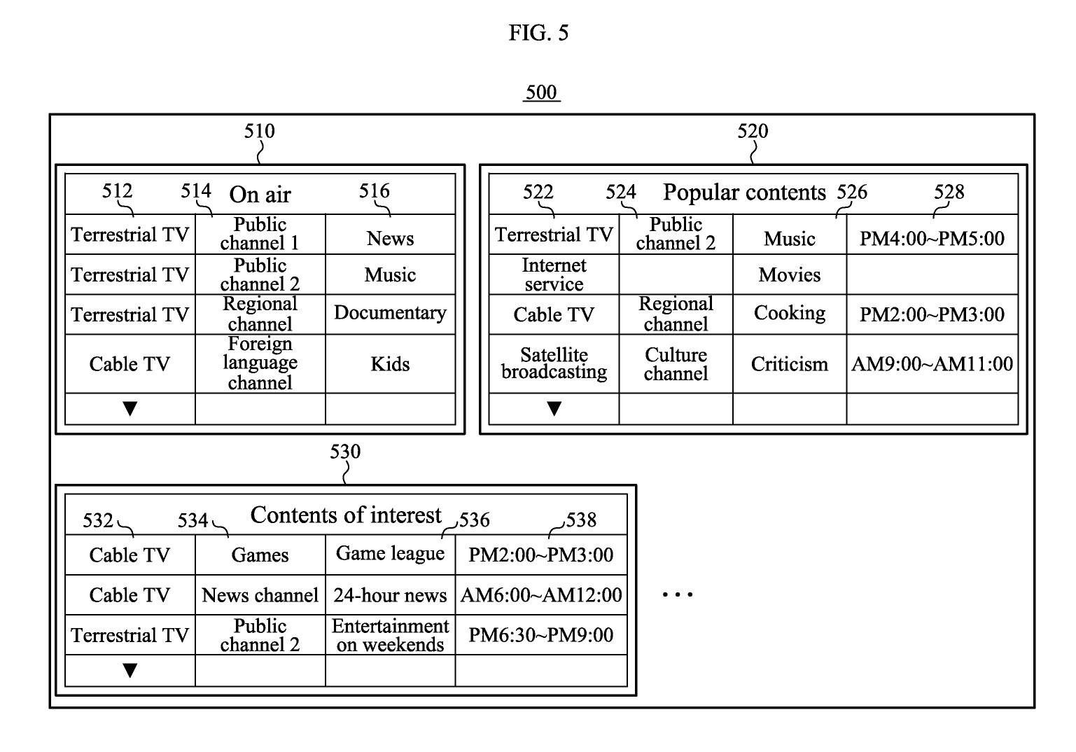

The integrated EPG generator 240 may generate an integrated EPG by integrating EPG information of each of the plurality of input sources. An example of an integrated EPG generated by the integrated EPG generator 240 will be further described with reference to FIG. 5.

The output unit 250 may output the integrated EPG.

The image display apparatus 100 may include the display unit 260 to display an image via a digital TV, as an example. The output unit 250 may transmit information about the integrated EPG to the display unit 260. The display unit 260 may physically display the integrated EPG based on information about the integrated EPG. Also, the output unit 250 may transmit information about the integrated EPG to an external display apparatus. The display apparatus may physically display the integrated EPG based on information about the integrated EPG.

The search unit 270 may search for content corresponding to a keyword, input by a user, from among contents that are provided by channels of the plurality of input sources. The integrated EPG generator 240 may include information about the retrieved content in the integrated EPG.

The recommendation unit 280 may select at least one recommendation content from among contents that are provided by the plurality of input sources. The integrated EPG generator 240 may include information about the at least one recommendation content in the integrated EPG.

The recommendation unit 280 may store personal selection history information about a channel and content selected by a user of the image display apparatus 100. The personal selection history information may be configured as a database and be stored within a local storage of the image display apparatus 100. To store the personal selection history information, the recommendation unit 280 may generate a user profile, and may configure the user profile as a database or may store the user profile in the local storage of the image display apparatus 100.

The integrated EPG may provide a user interface for generating, storing, and displaying the user profile and the personal selection history information.

The recommendation unit 280 may select recommendation content based on the personal selection history information. The recommendation unit 280 may transmit personal selection history information or content recommendation information to an Internet broadcasting server, for example, a broadcast portal that provides an input source. The content recommendation information is information for recommending content estimated to be preferred by the user. The internet broadcasting server may provide the selected content to the image display apparatus 100 via the input source, based on the personal selection history information or the content recommendation information.

A content recommendation server may determine popular content among contents of a predetermined input source by collecting search preferences of a plurality of users on the Internet. Also, the recommendation unit 280 may receive information about the popular content from the content recommendation server, or may select the popular content as the recommendation content. The recommendation unit 280 may receive information about the popular content from the content recommendation server by calling an application programming interface (API) provided by the content recommendation server.

The content recommendation server may specially treat content of a predetermined input source in determining popular content. For example, the content recommendation server may increase or decrease a rate in which the content of the predetermined input source is determined as the popular content. Accordingly, a frequency that the content of the predetermined input source is displayed for a user through the integrated EPG may be increased, and an opportunity that the content may be selected by the user may also be increased.

Also, the content recommendation server may receive personal selection history information of users from a plurality of image display apparatus 100, and may research a real-time rating by analyzing the received personal selection history information. The content recommendation server may determine that predetermined content is popular based on the analysis result.

The decoder 290 may extract content that is selected by the user from among contents provided by the plurality of input sources, from an input source that provides the content. The image display apparatus 100 may simultaneously or sequentially process signals of the plurality of input sources including a terrestrial broadcasting, a satellite broadcasting, a cable broadcasting, and the like. The decoder 290 may integrate and thereby decode signals of the input sources, and may extract predetermined content through decoding.

Unlike an existing EPG that outputs only information about a single input source, the integrated EPG may provide, within a single screen, information about contents that are provided by channels of the plurality of input sources that are received via various physical ports. Accordingly, to view desired content, the user may need to recognize in advance a channel of an input source that provides the desired content. Also, to view the desired content or a channel via which the content is transmitted, the user may not need to select a predetermined input source using a remote controller or an input unit, for example, a button of a panel, of the image display apparatus 100.

Also, the image display apparatus 100 is booted up to thereby generate the integrated EPG. Therefore, the moment the user turns on the image display apparatus 100, the user may instantaneously select and view desired content.

FIG. 3 is a diagram to describe a method of identifying an input source according to an exemplary embodiment of the present invention.

An input source may be identified by employing a different method based on a type of the input source.

The input source identifying unit 220 can identity information about a predetermined input source among a plurality of input sources, based on a type of the port 212 that is connected by the predetermined input source. For example, the input source identifying unit 220 can identify, as a terrestrial broadcasting input source, an input source that is connected to a terrestrial broadcasting input port.

The predetermined input source may provide information, for example, an identifier about the input source to the image display apparatus 100. For example, when the input source is connected to the image display apparatus 100 via a digital port such as an HDMI, a signal of the input source may include information about the content and information about the input source. The input source identifying unit 220 may identify a predetermined input source among the plurality of input sources by receiving information about the input source via the port 212 that is connected by the input source.

The input source identifying unit 220 can identify a predetermined input source among the plurality of input sources by receiving information about the s input source from a user. With respect to the input source connected to a predetermined port, the user can configure a provider of the input source, an apparatus name, for example, a name of a set-top that provides a signal or a model name, a service name, and the like through a user interface that is provided by the image display apparatus 100. The input source identifying unit 220 can identify an input source based on information configured by the user.

FIG. 4 is a diagram illustrating a method of receiving EPG information of an input source according to exemplary embodiments of the present invention.

The EPG information receiver 230 may receive EPG information of a predetermined input source among the plurality of input sources via the port 212 that is connected by the input source. That is, the EPG information receiver 230 may directly detect and thereby obtain EPG information of a predetermined input source from a signal of the input source that is received via the port 212. For example, when the input source is a terrestrial digital TV broadcasting, the input source may include EPG information about contents.

The EPG information receiver 230 may request a server 420 for EPG information of a predetermined input source among the plurality of input sources over a network that is connected to a network port 410. When the EPG information receiver 230 requests the server 420 for EPG information of the input source, the server 420 can transmit the EPG information of the input source to the EPG information receiver 230.

The network port 410 may be one of the ports 212. That is, the network port 410 may be connected to at least one input source among the plurality of input sources. The server 420 may provide EPG information of the input source over a network such as the Internet. The server 420 may be operated by the same entity as an entity, for example, a service provider that provides the input source. Also, the server 420 may provide the input source together with the EPG information.

To request the server 420 for EPG information, the EPG information receiver 230 may receive, from the input source identifying unit 220, information used to identify the input source. The information used to identify the input source may include information required to request EPG information such as an address of the server 420 and the like.

The server 420 may provide EPG information of all of or a portion of the plurality of input sources. The server 420 may provide the EPG information in a form of a web service. That is, the server 420 may be a broadcast portal that provides the EPG information. In this case, the image display apparatus 100 may receive EPG information of each of the plurality of input sources from the server 420.

FIG. 5 is a diagram illustrating a configuration of an integrated EPG according to exemplary embodiments of the present invention.

The integrated EPG may configure a dashboard 500. The dashboard 500 may include at least one widget. Referring to FIG. 5, a first widget 510, a second widget 520, and a third widget 530 are provided. Each widget may include information about at least one content provided by channels of a plurality of input sources. The dashboard 500 may provide a user interface that enables a user to quickly access content displayed on the dashboard 500.

Widgets within the dashboard 500 may display information about contents of different categories.

The first widget 510 may display information about contents that are on air. Unlike a VOD-based Internet input source, a broadcast input source may provide contents in real time. Accordingly, contents provided through the broadcast input source may need to be integrally displayed within the dashboard 500 using separate categories instead of selectively displaying information by search. The first widget 510 may include information 512 about an input source that provides content in real time, information 514 about a channel that provides the content, and information 516 about a name of the content.

The second widget 520 may display information about popular contents. The popular contents may be a portion of recommendation contents that are selected by the recommendation unit 280. The popular contents may be selected based on information about the popular contents provided by the content recommendation server, described above with reference to FIG. 2. The second widget 520 may include information 522 about an input source that provides popular contents, information 524 about a channel that provides the popular content, information 526 about a name of the popular content, and information 528 about a day and time when the popular content is broadcasted.

The third widget 530 may display information about contents of interest. The contents of interest may be a portion of recommendation contents that are selected by the recommendation unit 280. The contents of interest may be recommendation contents that are selected based on personal selection history information. The third widget 530 may include information 532 about an input source that provides content of interest, information 534 about a channel that provides the content of interest, information 536 about a name of the content of interest, information 538 about a day and time when the interest of content is broadcasted.

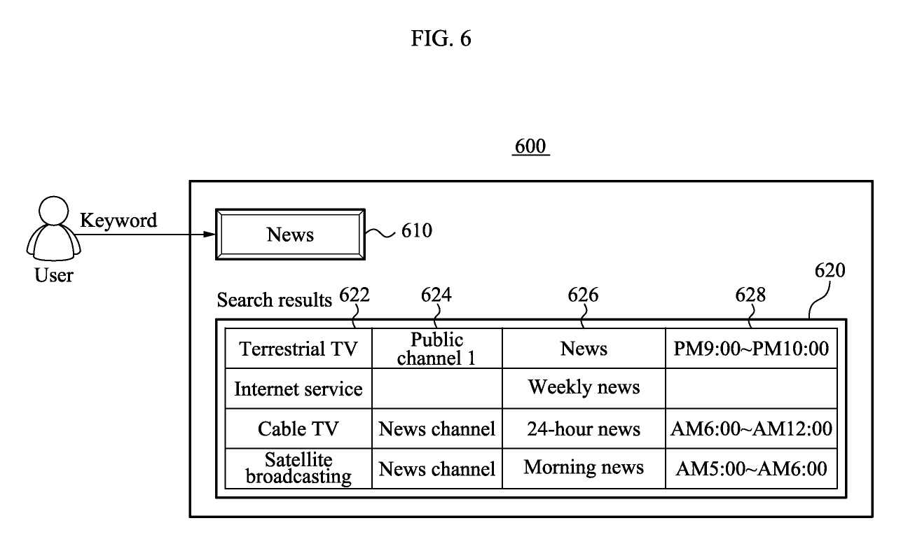

FIG. 6 is a diagram illustrating a content search according to exemplary embodiments of the present invention.

An integrated EPG or the dashboard 500 of FIG. 5 may provide a content search user interface 600 for searching for content.

A user may input a keyword into a keyword input window 100 of the content search user interface 600, and may make a request for searching for content corresponding to the keyword. The content corresponding to the keyword may indicate that information about the content, for example, a title or a description of the content includes the keyword.

The search unit 270 may search for the content corresponding to the keyword input by the user, from among contents that are provided by a plurality of input sources. A list of the retrieved contents may be determined based on personal selection history information or content recommendation information described above with reference to FIG. 2. For example, based on the personal selection history information or content recommendation information, content having a relatively high preference may be positioned ahead of content having a relatively low preference within a list of retrieved contents. Accordingly, the user may easily identify preferred content from among a large number of retrieved contents in the list.

A search result widget 620 may display information about retrieved contents. The search result widget 620 may include information 622 about an input source that provides retrieved content, information 624 about a channel that provides the retrieved content, information 626 about a name of the retrieved content, and information 628 about a day and time when the retrieved content is broadcasted.

The content search user interface 600 may have a similar configuration as a content search user interface provided by the server 420 of FIG. 4. Accordingly, the user may search for desired content from within the integrated EPG using the same scheme that is used when searching for and playing the content using the server 420.

Also, a search algorithm used by the search unit 270 may be similar as a search algorithm provided by the server 420.

Instead of selecting an input source and a channel, the user may select desired content by searching for the content and view the selected content. Also, the user may select and view contents of various input sources using a single scheme provided by the integrated EPG.

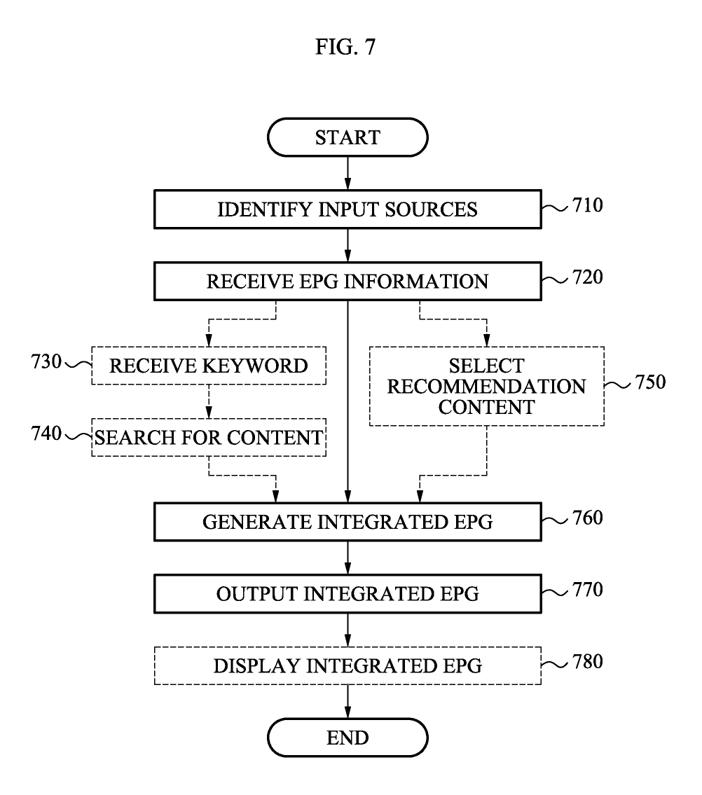

FIG. 7 is a flowchart of a process for illustrating a method of providing an EPG in an image display apparatus according to exemplary embodiments of the present invention.

In operation 710, the input source identifying unit 220 may identify a plurality of input sources. Each of the plurality of input sources may provide a signal to the image display apparatus 100.

In some examples, in operation 710, the input source identifying unit 220 may identify a first input source among the plurality of input sources by receiving information about the first input source via the port 212 that is connected by the first input source.

Also, in operation 710, the input source identifying unit 220 may identify a second input source among the plurality of input sources by receiving information about the second input source from a user.

In operation 720, the EPG information receiver 230 may receive EPG information of each of the plurality of input sources.

In some examples, in operation 720, the EPG information receiver 230 may receive EPG information of a third input source among the plurality of input sources via the port 212 that is connected by the third input source.

Also, in operation 720, the EPG information receiver 230 may request the server 420 for EPG information of a fourth input source among the plurality of input sources over a network, and may receive EPG information of the fourth input source from the server 420.

In operation 760, the integrated EPG generator 240 may generate an integrated EPG by integrating EPG information. The integrated EPG may configure the dashboard 500 that includes at least one widget. Each widget may include information at least one content provided by the plurality of input sources.

In operation 770, the output unit 250 may output the integrated EPG.

A method of providing the EPG by the image display apparatus 100 may selectively include the following operations 730, 740, 750, and 780 by way of configurations.

In operation 730, the search unit 270 may receive a keyword from the user. In operation 740, the search unit 740 may search for content corresponding to the keyword from among contents that are provided by channels of the plurality of input sources. The integrated EPG may include information about the retrieved content.

In operation 750, the recommendation unit 280 may select at least one recommendation content from among contents that are provided by channels of the plurality of input sources. In this example, the integrated EPG may include information about the recommendation content.

In operation 780, the output unit 250 may display the integrated EPG.

Technical description according to exemplary embodiments of the present invention described above with reference to FIGS. 1 through 6 may be applicable as is to the present exemplary embodiments and thus, further detailed description will be omitted to avoid unnecessarily obscuring the present invention.

All of or a portion of the above constituent elements may be performed by a single controller (not shown). The controller may be configured as a single or multi-chip, processor, or core. Each of the constituent elements may indicate a function, a library, a service, a process, a thread, or a module that is performed by the controller.

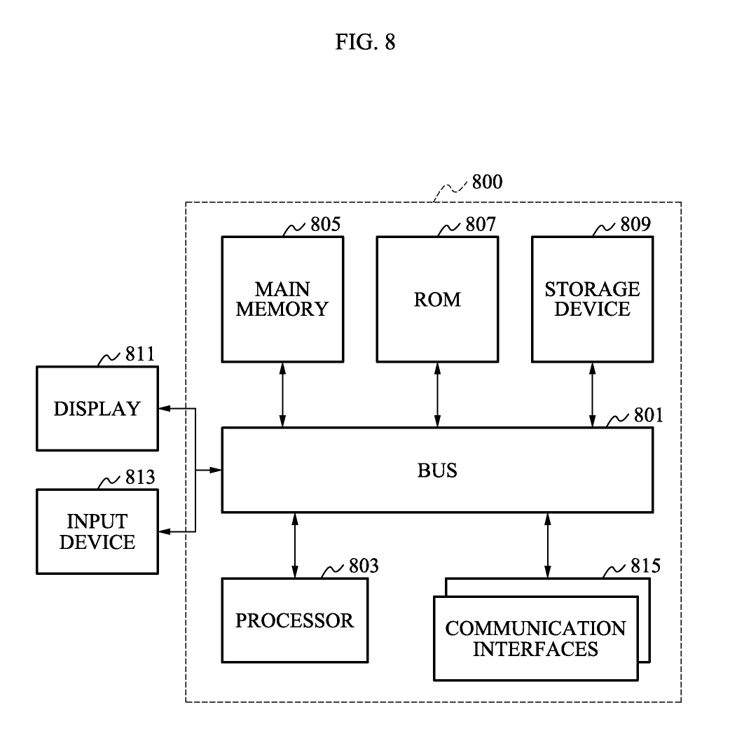

One of ordinary skill in the art would recognize that system and method for providing integrated electronic program guide (EPG) od multi-input sources may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 8.

FIG. 8 illustrates exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled with the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may execute an application.

The term “computer-readable medium” or “storage device” as used herein refers to any medium that participates in providing instructions to the processor 803 for execution. Such a medium may take many forms, including but not limited to non-volatile media, volatile media8. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone or cable line. A modem of a local system receives the data on the telephone line and uses a wireless transmitter to convert the data to a signal and transmit the signal to a portable computing device, such as a personal digital assistant (PDA) or a laptop. A detector on the portable computing device receives the information and instructions borne by the signal and places the data on a bus. The bus conveys the data to main memory, from which a processor retrieves and executes the instructions. The instructions received by main memory can optionally be stored on storage device either before or after execution by processor. One or more units associated with a processor or computing device are configured to perform an operation of the exemplary embodiments. These units can be self-contained units or hardware components, such as an assembly of electronic components, a computing embedded system, a computer module, or computer software modules which can perform a defined task executable by the processor or the computing device and can be linked with other units or components to form a larger system.

According to exemplary embodiments of the present invention, there is provided a method and apparatus for generating an integrated EPG by receiving EPG information of each of a plurality of input sources.

Using the integrated EPG, a user may not need to select a predetermined input source from among the plurality of input sources to view desired content.

Using the integrated EPG, the user may view contents that are provided by the plurality of input sources based on a single manipulation scheme.

Using the integrated EPG, the user may also verify and manipulate a list of popular contents and a list of contents of interest using an integrated user interface, in addition to a list of contents that are on air.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of providing electronic program guide (EPG) information associated with an input display apparatus, the method comprising:
identifying a plurality of input sources, each input source providing a signal to the image display apparatus;
receiving EPG information of each of the plurality of input sources;
generating an integrated EPG by integrating the EPG information; and
outputting the integrated EPG.

2. The method of claim 1, wherein identifying the plurality of input sources comprises:
identifying a first input source among the plurality of input sources by receiving information of the first input source via a port that is connected by the first input source.

3. The method of claim 1, wherein identifying the plurality of input sources comprises:
identifying a second input source among the plurality of input sources by receiving information of the second input source from a user input.

4. The method of claim 1, wherein receiving EPG information of each of the plurality of input sources comprises:
receiving EPG information of a third input source among the plurality of input sources via a port that is connected by the third input source.

5. The method of claim 1, wherein receiving EPG information of each of the plurality of input sources comprises:
requesting a server for EPG information of a fourth input source among the plurality of input sources over a network; and
receiving EPG information of the fourth input source from the server.

6. The method of claim 1, wherein the plurality of input sources comprises at least one of a broadcast input source, an Internet input source, and a personal media input source.

7. The method of claim 1, wherein the integrated EPG constitutes a dashboard that comprises at least one widget, and each of the at least one widget comprises information of at least one content that is provided by channels of the plurality of input sources.

8. The method of claim 1, further comprising:
receiving a keyword from a user; and
searching for content corresponding to the keyword from among contents that are provided by channels of the plurality of input sources,
wherein the integrated EPG comprises information about the retrieved content.

9. The method of claim 1, further comprising:
selecting at least one recommendation content from among contents that are provided by channels of the plurality of input sources,
wherein the integrated EPG comprises information about the at least one recommendation content.

10. A non-transitory computer-readable recording medium comprising a program, which when executed by a processor, performs the method of:
identifying a plurality of input sources, each input source providing a signal to the image display apparatus;
receiving EPG information of each of the plurality of input sources;
generating an integrated EPG by integrating the EPG information; and
outputting the integrated EPG.

11. An image display apparatus, comprising:
at least one port to receive a signal;
an input source identifying unit to identify a plurality of input sources, wherein a signal of each of the plurality of input sources is provided to the image display apparatus via one of the at least one port;
an electronic program guide (EPG) information receiver to receive EPG information of each of the plurality of input sources;
an integrated EPG generator to generate an integrated EPG by integrating the EPG information; and
an output unit to output the integrated EPG.

12. The apparatus of claim 11, wherein the input source identifying unit is configured to identify a first input source among the plurality of input sources by receiving information about the first input source via a port that is connected by the first input source.

13. The apparatus of claim 11, wherein the input source identifying unit is configured to identify a second input source among the plurality of input sources by receiving information about the second input source from a user.

14. The apparatus of claim 11, wherein the EPG information receiver is configured to receive EPG information of a third input source among the plurality of input sources via a port that is connected by the third input source.

15. The apparatus of claim 11, wherein the EPG information receiver is configured to request a server for EPG information of a fourth input source among the plurality of input sources over a network, and to receive EPG information of the fourth input source from the server.

16. The apparatus of claim 11, wherein the plurality of input sources comprises at least one of a broadcast input source, an Internet input source, and a personal media input source.

17. The apparatus of claim 11, wherein the integrated EPG comprises a dashboard that comprises at least one widget, and each of the at least one widget comprises information about at least one content that is provided by channels of the plurality of input sources.

18. The apparatus of claim 11, further comprising:
a search unit to search for content corresponding to a keyword input by a user from among contents that are provided by channels of the plurality of input sources,
wherein the integrated EPG generator comprises information about the retrieved content in the integrated EPG.

19. The apparatus of claim 11, further comprising:
a recommendation unit to select at least one recommendation content from among contents that are provided by channels of the plurality of input sources,
wherein the integrated EPG generator comprises information about the at least one recommendation content in the integrated EPG.
